(19) United States
(12) Patent Application Publication
(10) Pub. No.: US 2023/0173436 A1
(43) Pub. Date: Jun. 8, 2023

(54) COATED SUBSTRATES THAT DEMONSTRATE PREFERENTIAL PERMEABILITY TO WATER, SUITABLE AS MEMBRANES FOR SEPARATING OIL-IN-WATER EMULSIONS

(71) Applicant: ACULON, INC., San Diego, CA (US)

(72) Inventors: Majid Monji, San Diego, CA (US); Eric L. Bruner, La Jolla, CA (US)

(21) Appl. No.: 18/077,453

(22) Filed: Dec. 8, 2022

Related U.S. Application Data
(60) Provisional application No. 63/287,222, filed on Dec. 8, 2021.

(51) Int. Cl. B01D 71/32; B01D 69/02; C02F 1/40; B01D 69/12

(52) U.S. Cl. CPC B01D 71/32; B01D 69/02; C02F 1/40; B01D 69/12; B01D 2325/02834; B01D 2325/36; B01D 2221/04; B01D 2239/0421; B01D 2257/702

(57) ABSTRACT

Water permeable coated substrates and filtration membranes are provided comprising: (a) a porous substrate; (b) an optional primer layer applied to a substrate surface (a), wherein the primer layer comprises silica and/or an organometallic compound; (c) a superhydrophilic coating layer applied to the porous substrate (a), or the primer layer (b), wherein the superhydrophilic layer comprises a superhydrophilic polymer or silicate; and (d)

an optional tie layer applied to the superhydrophilic coating layer (c), wherein the tie layer comprises silica and/or an organometallic compound. The water permeable coated substrates and filtration membranes may further include (e) an oleophobic coating layer applied to the superhydrophilic coating layer (c), or the tie layer (d), wherein the oleophobic coating layer comprises a fluoropolymer having reactive functional groups. Each layer of the coated substrate is covalently bonded to adjacent layers. Methods of separating an oil-in-water emulsion are also disclosed.

### RELATED APPLICATION

The present invention claims priority to U.S. Provisional Patent Application Ser. No. 63/287,222 filed Dec. 8, 2021 titled “Coated Substrates that Demonstrate Preferential Permeability to Water, Suitable as Membranes for Separating Oil-In-Water Emulsions” which is incorporated herein by reference.

### FIELD OF THE INVENTION

The present invention relates to water permeable coated substrates and filtration membranes, and their use in methods of separating oil-in-water emulsions and colloids.

### BACKGROUND OF THE INVENTION

Changing the surface energy of a substrate is of great value in many diverse industries and products including healthcare, oil, gas and energy production, electronics, and cosmetics. Depending on the needs and applications, substrate surfaces can be customized to exhibit hydrophilic, hydrophobic, oleophobic and oleophilic properties.

Scientifically, liquids with lower surface tensions (e.g., oil with surface tensions <30 mN/m) tend to wet solid surfaces (with specific surface energy) more than liquids with higher surface tensions (e.g., water with surface tension of 72.8 mN/m). Coated surfaces may be prepared to yield different contact angles for liquids with higher surface tensions compared to those with lower surface tensions.

One of the greatest challenges in oil, gas and energy production and their impact on the environments is the treatment of generated wastewater that contains oil and many smaller hydrocarbons as contaminants. Industrial membranes which are used to clean waste streams are usually permeable toward oil and reject the water portions. Such membranes are useful for emulsions with oil as the continuous phase rather than water; otherwise, this system is not economically feasible. For cases where water is the continuous phase, a membrane with different properties is needed that is permeable to water and repels the oil.

It would be desirable to provide water-permeable coated substrates and filtration membranes useful for separating oil-in-water emulsions such as oil production wastewater streams.

### SUMMARY OF THE INVENTION

Water permeable coated substrates and filtration membranes are provided comprising: (a) a porous substrate; (b) an optional primer layer applied to a surface of the substrate (a), wherein the primer layer comprises silica and/or an organometallic compound; (c) a superhydrophilic coating layer applied to the porous substrate (a) if the primer layer (b) is not present, or the primer layer (b) if it is present, wherein the superhydrophilic layer comprises a superhydrophilic polymer or silicate; and (d) an optional tie layer applied to the superhydrophilic coating layer (c), wherein the tie layer comprises silica and/or an organometallic compound and is the same as or different from the primer layer (b).

The water permeable coated substrates and filtration membranes provided under the invention may further include (e) an oleophobic coating layer applied to the superhydrophilic coating layer (c) if the tie layer (d) is not present, or the tie layer (d) if it is present, wherein the oleophobic coating layer comprises a fluoropolymer having reactive functional groups. Each layer of the coated substrate is covalently bonded to adjacent layers. Each coating layer may be applied to all, or at least a portion of, the underlying layer; often at least 80% of the surface area, up to the entire surface, is covered.

Also provided are methods of separating an oil-in-water emulsion, comprising: (i) contacting the oil-in-water emulsion with the water-permeable filtration membrane described above; and (ii) allowing the water to permeate through the filtration membrane.

These and other advantages of the present invention are described below in connection with the attached figure.

### BRIEF DESCRIPTION OF THE DRAWINGS

FIG. 1 (FIG. 1) is a schematic cross-sectional representation of an exemplary coated substrate according to the present invention, that includes a primer layer and a tie layer.

### DETAILED DESCRIPTION OF THE INVENTION

Other than in any operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used in this specification and the appended claims, the articles “a,” “an,” and “the” include plural referents unless expressly and unequivocally limited to one referent.

The various aspects and examples of the present invention as presented herein are each understood to be non-limiting with respect to the scope of the invention.

As used in the following description and claims, the following terms have the meanings indicated below:

The terms “on”, “appended to”, “affixed to”, “bonded to”, “adhered to”, or terms of like import means that the designated item, e.g., a coating, film or layer, is either directly connected to (in contact with) the object surface, or indirectly connected to the object surface, e.g., through one or more other coatings, films or layers.

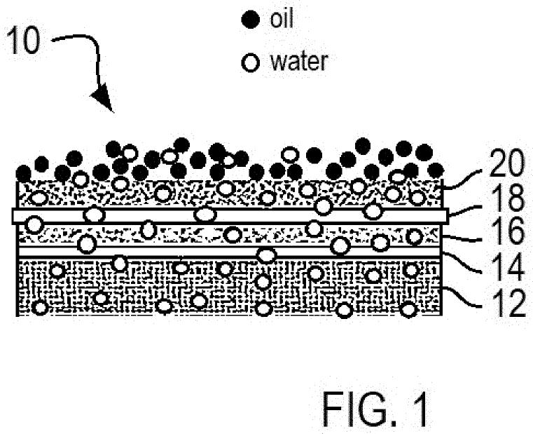

FIG. 1 illustrates a schematic example of cross section of a coated substrate 10 according to the present invention, wherein a primer layer 14 is applied to a porous substrate 12, a superhydrophilic coating layer 16 is applied to the primer layer 14, a tie layer 18 is applied to the superhydrophilic coating layer 16, and an oleophobic coating layer 20 is applied to the tie layer 18. The oleophobic coating layer 20 forms the outermost layer of the coated substrate 10.

The water permeable coated substrates and filtration membranes of the present invention comprise (a) a porous substrate 12. The porous substrate often has surface reactive functional groups. Substrates suitable for use in the preparation of the coated substrates 10 and filtration membranes of the present invention can include a metal such as aluminum (including aluminum oxide), tantalum, stainless steel, or any other substrate commonly used in the preparation of filtration membranes, such as polymers having organic or inorganic backbones. Examples of polymers having inorganic backbones include polysiloxanes, polysulfides, polyphosphazenes, and polythiazyls. Examples of polymers having organic backbones include polyester, polyphenylene sulfide, polyolefins, polyesters and the like. The substrates may be inherently porous or may be perforated with ordered or random microarrays of microchannels. “Microchannels” are understood to be micro-dimensional fluidic channels (e.g., having average diameters on a micron or nanometer scale). In microtechnology, a microchannel is understood to have a hydraulic diameter below 1 millimeter. In particular examples of the present invention, the substrate (a) demonstrates average pore sizes greater than 100 nm, or even greater than 300 nm. Typically the average pore size of the substrate (a) is less than 1 mm.

The porous substrate (a) preferably has hydroxyl or other functional groups that react with metal alkoxides or sodium silicate on the surface. The functional groups allow for affinity and adhesion between the substrate (a) and a coating layer applied thereto, such as by simple polarity, hydrogen bonding or even covalent bonding.

The substrate 12 may take any shape as desired for the intended application, such as flat, curved, bowl-shaped, tubular, or flexible freeform. For example, the substrate may be in the form of a flat plate having two opposing surfaces. Typically the coatings are applied to one of the two opposing surfaces of the substrate 12. The water permeable coated substrates of the present invention may form the floor of a holding tank, for use in a method of separating an oil-in-water emulsion. The separation may be done at gravity pressure without any vacuum or pressure, which saves energy by eliminating a need for pumping. The thickness of the substrate depends on the volume and composition of the stream to be treated. In certain examples, it may range from 10 to 1000 microns, or 100 to 1000 microns, or 10 to 500 microns.

Prior to application of any coatings, the substrate 12 may be cleaned such as by argon plasma treatment or with a solvent such as lonox 13416 or Cybersolv 141-R, both available from Kyzen, or 905 and 907 from Aculon Inc.

The coated substrates 10 and filtration membranes of the present invention may further comprise (b) a primer layer 14 applied to at least a portion of the substrate (a). The primer layer (b) comprises silica and/or an organometallic compound; often the primer comprises silica nanoparticles that are functionalized with an organometallic compound. The organometallic compound is typically derived from an organo metal in which the metal comprises a transition metal. Transition metals include elements in the d-block of the periodic table (i.e., having valence electrons in the d orbital), as well as those in the f-block (the lanthanide and actinide series, also called “inner transition metals”, having valence electrons in the f orbital.) Often the metal is selected from at least one of La, Hf, Ta, W, and niobium. The organo portion of the metal is usually an alkoxide containing from 1 to 18, often 2 to 8 carbon atoms such as ethoxide, propoxide, isopropoxide, butoxide, isobutoxide and/or tertiary butoxide. The alkoxides may be in the form of simple esters and polymeric forms of the esters. For example, with the metal Ta, the simple esters would be Ta(OR)₅ where each R is independently C₁ to C₁₈ alkyl. Polymeric esters would be obtained by condensation of the alkyl esters mentioned above and typically would have the structure: RO—[Ta(OR)₃—O—]ₓR where each R is independently defined as above and x is a positive integer. Besides alkoxides, other ligands can be present such as acetyl acetonates, chloride, alkanolamine and lactate, etc. Note that the phrase “and/or” when used in a list is meant to encompass alternative embodiments including each individual component in the list as well as any combination of components. For example, the list “A, B, and/or C” is meant to encompass seven separate embodiments that include A, or B, or C, or A +B, or A +C, or B+C, or A +B+C.

Commercially available compositions for use as the primer layer (b) include RDA, available from Aculon Inc. The primer layer (b) may be applied to the substrate (a) by conventional means such as dipping, rolling, spraying, wiping to form a film, or by curtain coating. The dry film thickness of the primer layer (b) is typically 100 nm to 100 microns, such as 500 nm to 1 micron.

The coated substrates and filtration membranes of the present invention further comprise (c) a superhydrophilic layer 16 applied to at least a portion of the primer layer 14 if it is present; otherwise, it may be applied to the substrate 12 in whole or in part. The superhydrophilic layer 16 comprises a superhydrophilic polymer. By “superhydrophilicity” is meant excess hydrophilicity, or attraction to water; in superhydrophilic materials, the contact angle of water is equal to zero degrees. Any superhydrophilic agent with a binding functionality may be used in the superhydrophilic layer (c). Specific examples include silicate and zwitterionic polymers such as polymers containing sulfobetaine and/or polydiallyldimethylammonium chloride (PDDA). In particular examples of the present invention, the superhydrophilic polymer comprises polydiallyldimethylammonium chloride having a weight average molecular weight of 50,000-500,000.

The superhydrophilic coating layer (c) may be applied by any of the conventional methods listed above. The dry film thickness of the superhydrophilic coating layer (c) is typically 100 nm to 100 microns, such as 500 nm to 1 micron.

The coated substrates and filtration membranes of the present invention may further comprise (d) a tie layer 18 applied to at least a portion of the superhydrophilic layer 16. The tie layer (d) may comprise any of the compositions suitable for use as the primer layer (b), and may be the same as or different from the primer layer (b). Usually the tie layer (d) is the same as the primer layer (b).

The tie layer (d) may be applied to the superhydrophilic coating layer (c) by any of the conventional methods listed above. The dry film thickness of the tie layer (d) is typically 1 to 100 nm, such as 5 to 20 nm.

The coated substrates and filtration membranes of the present invention further comprise (e) an oleophobic coating layer 20 applied to the tie layer (d) if it is present, or to at least a portion of the superhydrophilic coating layer (c). The oleophobic coating layer (e) usually comprises a fluoropolymer having reactive functional groups. By “oleophobic” is meant having an oil rating of at least 5A when subjected to AATCC Test Method 118-1997, and/or an oil contact angle (via half angle method) of at least 30 degrees. Examples include any perfluoralkyl or perfluoroalkylether, preferably with groups reactive toward organometallics; i.e., that can participate in ligand metathesis, such as silanol functional groups. Suitable fluoropolymers include fluoroethylene-alkyl vinyl ether alternating copolymers (such as those described in U.S. Pat. No. 4,345,057) available from Asahi Glass Company under the name LUMIFLON™; fluoroaliphatic polymeric esters commercially available from 3M of St. Paul, Minn. under the name FLUORAD™; and perfluorinated hydroxyl functional (meth)acrylate resins. The fluoropolymer may, for example, be prepared by polymerizing one or more fluorinated ethylenically unsaturated monomers such as a fluoroethylene or fluoropropylene and fluoro-functional ethylenically unsaturated ester monomers such as fluoro-functional (meth)acrylate monomers and 2-Methyl-2-propenoic acid tridecafluorooctyl ester, with or without non-fluoro-functional ethylenically unsaturated monomers, using conventional polymerization techniques. Other polymers that are suitable for use as the fluorinated polymer include copolymers, such as terpolymers, of vinylidene fluoride, hexafluoropropylene, tetrafluoroethylene and/or perfluoromethylvinyl ether. Examples of such polymers are VITON A-100 and VITON GF-200S, fluoroelastomers commercially available from The Chemours Company. Each of the fluorinated polymers described above may be used individually or in combination with each other. Fluorinated solvents include EnSolv NEXT™ solvents, available from Envirotech International. Inc.; VERTREL™ solvents available from E. I. DuPont de Nemours; and FLUORINERT™, NOVEC™, and HFE-7500 fluorosolvents, all available from 3M.

Often the oleophobic coating layer (e) comprises a fluorine-containing nonionic surfactant and an amphoteric, fluorine-containing betaine surfactant. Commercially available fluorine-containing nonionic surfactants include CAPSTONE™ FS-3100. Commercially available amphoteric, fluorine-containing betaine surfactants include CAPSTONE™ FS-50. Both are available from The Chemours Company.

Commercially available compositions for use as the oleophobic coating layer (e) include several available from Aculon, Inc., such as NANOPROOF 5.0, and NANOPROOF 12.x, XT1, and FS50. In certain examples of the present invention, the oleophobic coating layer (e) is essentially free of perfluorooctanoic acid. By “essentially free” of a material is meant that a composition has only trace or incidental amounts of a given material, and that the material is not present in an amount sufficient to affect any properties of the composition. These materials are not essential to the composition and hence the composition is free of these materials in any appreciable or essential amount. If they are present, it is in incidental amounts only, typically less than 0.1 percent by weight, based on the total weight of solids in the composition.

The oleophobic coating layer (e) may be applied by any of the conventional methods listed above. The dry film thickness of the oleophobic coating layer (e) is typically 1 to 100 nm, such as 1 to 20 nm.

Adjuvant materials may be present in any of the above film-forming compositions. Examples include solvents as noted above, viscosity (rheology) modifying components such as shear thinning or thixotropic compounds, stabilizers such as sterically hindered alcohols and acids, surfactants and anti-static agents. Exemplary organic solvents include alcohols such as methanol, ethanol and propanol, aliphatic hydrocarbons such as hexane, isooctane and decane; ethers, for example, tetrahydrofuran, and dialkylethers such as diethylether.

The adjuvants, if present, are individually present in each of the compositions used to form each layer in amounts of up to 99 percent by weight (usually primarily solvent), or up to 95 percent by weight, or up to 75 percent by weight, based on the non-volatile (solids) content of the composition.

The compositions used to form each coating layer can be prepared by mixing all of the components at the same time with low shear mixing or by combining the ingredients in several steps. The organometallic compounds are reactive with moisture, and care should be taken when organometallic compounds are used that moisture is not introduced with the solvent or adjuvant materials and that mixing is conducted in a substantially anhydrous atmosphere.

After application of each coating layer, any solvent in the coating composition is permitted to evaporate and curing of any reactive functional groups may occur. Interlayer covalent bonding of compounds in adjacent coating layers also occurs. This can be accomplished by heating to 50 to 200° C., often 60 to 85° C., or by simple exposure to ambient temperature, which is usually from 20 to 25° C.

The term “cure”, “cured” or similar terms, as used in connection with a cured or curable composition, e.g., a “cured composition” of some specific description, means that at least a portion of any polymerizable and/or crosslinkable components that form the curable composition is polymerized and/or crosslinked. Additionally, curing of a composition refers to subjecting said composition to curing conditions such as those listed above, leading to the reaction of the reactive functional groups of the composition. The term “at least partially cured” means subjecting the composition to curing conditions, wherein reaction of at least a portion of the reactive groups of the composition occurs. The composition can also be subjected to curing conditions such that a substantially complete cure is attained and wherein further curing results in no significant further improvement in physical properties, such as hardness.

The coated substrates 10 of the present invention are water-permeable and are particularly advantageous for use as filtration membranes or coalescers in methods of separating oil-in-water emulsions and colloids, such as wastewater from oil production processes.

Whereas particular embodiments of this invention have been described above for purposes of illustration, it will be evident to those skilled in the art that numerous variations of the details of the present invention may be made without departing from the scope of the invention as defined in the appended claims.

What is claimed is:

1. A water-permeable coated substrate comprising:
(a) a porous substrate;
(b) an optional primer layer applied to at least a portion of a surface of the substrate (a), wherein the primer layer comprises silica and/or an organometallic compound;
(c) a superhydrophilic coating layer applied to at least a portion of the porous substrate (a), or the primer layer (b) if it is present, wherein the superhydrophilic layer comprises a superhydrophilic polymer or silicate; and
(d) an optional tie layer applied to at least a portion of the superhydrophilic coating layer (c), wherein the tie layer comprises silica and/or an organometallic compound and is the same as or different from the primer layer (b).

2. The coated substrate of claim 1, further including (e) an oleophobic coating layer applied to at least a portion of the superhydrophilic coating layer (c), or the tie layer (d) if it is present, wherein the oleophobic coating layer comprises a fluoropolymer having reactive functional groups; wherein each layer of the coated substrate is covalently bonded to adjacent layers.

3. The coated substrate of claim 2, wherein the substrate (a) comprises a metal, polyester or polyphenylene sulfide (PPS).

4. The coated substrate of claim 2, wherein the substrate (a) demonstrates average pore sizes greater than 100 nm.

5. The coated substrate of claim 2, wherein the primer layer (b) is present and comprises silica nanoparticles that are functionalized with a metal alkoxide.

6. The coated substrate of claim 2, wherein the superhydrophilic layer comprises polydiallyldimethylammonium chloride having a weight average molecular weight of 50,000-500,000.

7. The coated substrate of claim 2, wherein the tie layer (d) is present and is the same as the primer layer (b).

8. The coated substrate of claim 2, wherein the oleophobic coating layer (e) comprises a fluorine-containing nonionic surfactant and an amphoteric, fluorine-containing betaine surfactant.

9. The coated substrate of claim 8, wherein the oleophobic coating layer (e) is essentially free of perfluorooctanoic acid, and wherein the oleophobic coating layer (e) demonstrates a dry film thickness of 1 nm to 100 nm.

10. The coated substrate of claim 2, wherein the coated substrate comprises a filtration membrane.

11. A water-permeable filtration membrane comprising:
(a) a porous substrate;
(b) an optional primer layer applied to at least a portion of a surface of the substrate (a), wherein the primer layer comprises silica and/or an organometallic compound;
(c) a superhydrophilic coating layer applied to at least a portion of the porous substrate (a), or the primer layer (b) if it is present, wherein the superhydrophilic layer comprises a superhydrophilic polymer or silicate; and
(d) an optional tie layer applied to at least a portion of the superhydrophilic coating layer (c), wherein the tie layer comprises silica and/or an organometallic compound and is the same as or different from the primer layer (b); and

12. The water-permeable filtration membrane of claim 11, further including (e) an oleophobic coating layer applied to at least a portion of the superhydrophilic coating layer (c), or the tie layer (d) if it is present, wherein the oleophobic coating layer comprises a fluoropolymer having reactive functional groups; wherein each layer of the coated substrate is covalently bonded to adjacent layers.

13. The water-permeable filtration membrane of claim 12, wherein the substrate (a) comprises a metal, polyester or polyphenylene sulfide (PPS), and, wherein the substrate (a) demonstrates average pore sizes greater than 100 nm.

14. The water-permeable filtration membrane of claim 12, wherein the primer layer (b) is present and comprises silica nanoparticles that are functionalized with a metal alkoxide.

15. The water-permeable filtration membrane of claim 12, wherein the superhydrophilic polymer comprises polydiallyldimethylammonium chloride having a weight average molecular weight of 50,000-500,000.

16. The water-permeable filtration membrane of claim 12, wherein the tie layer (d) is present and is the same as the primer layer (b).

17. The water-permeable filtration membrane of claim 12, wherein the oleophobic coating layer (e) comprises a fluorine-containing nonionic surfactant and an amphoteric, fluorine-containing betaine surfactant.

18. The water-permeable filtration membrane of claim 17, wherein the oleophobic coating layer (e) is essentially free of perfluorooctanoic acid.

19. The water-permeable filtration membrane of claim 12, wherein the oleophobic coating layer (e) demonstrates a dry film thickness of 1 nm to 100 nm.

20. A method of separating an oil-in-water emulsion, comprising:
(i) contacting the oil-in-water emulsion with a water-permeable filtration membrane; and
(ii) allowing the water to permeate through the filtration membrane, wherein the water-permeable filtration membrane comprises:
(a) a porous substrate;
(b) an optional primer layer applied to at least a portion of a surface of the substrate (a), wherein the primer layer comprises silica and/or an organometallic compound;
(c) a superhydrophilic coating layer applied to at least a portion of the porous substrate (a), or the primer layer (b) if it is present, wherein the superhydrophilic layer comprises a superhydrophilic polymer or silicate;
(d) an optional tie layer applied to at least a portion of the superhydrophilic coating layer (c), wherein the tie layer comprises silica and/or an organometallic compound and is the same as or different from the primer layer (b); and
(e) an oleophobic coating layer applied to at least a portion of the superhydrophilic coating layer (c), or the tie layer (d) if it is present, wherein the oleophobic coating layer comprises a fluoropolymer having reactive functional groups; wherein each layer of the coated substrate is covalently bonded to adjacent layers.
